(19) United States
(12) Patent Application Publication
(10) Pub. No.: US 2024/0005668 A1
(43) Pub. Date: Jan. 4, 2024

(54) Vehicle and Control Method Thereof

(71) Applicants: Hyundai Motor Company, Seoul (KR); Kia Corporation, Seoul (KR)

(72) Inventors: Jungwon Lee, Seoul (KR); Junsik An, Seoul (KR); Jihee Han, Seoul (KR)

(21) Appl. No.: 18/065,932

(22) Filed: Dec. 14, 2022

(30) Foreign Application Priority Data
Jun. 29, 2022 (KR) 10-2022-0079757

(51) Int. Cl. G06V 20/58; G06V 10/77; G06V 10/54; G06V 10/60; G06V 10/36

(52) U.S. Cl. CPC G06V 20/58; G06V 10/77; G06V 10/54; G06V 10/60; G06V 10/36

(57) ABSTRACT

An embodiment vehicle includes a camera and a controller including a processor configured to process image data acquired from the camera, wherein the controller is configured to determine whether a light source or a texture is present in a first image acquired by processing the image data, perform filtering of the first image based on the light source or the texture being present, convert the first image into a second image, and store the first image and the second image as learning data for object recognition.

### CROSS-REFERENCE TO RELATED APPLICATIONS

This application claims the benefit of Korean Patent Application No. 10-2022-0079757, filed on Jun. 29, 2022, which application is hereby incorporated herein by reference.

### TECHNICAL FIELD

The disclosed invention relates to a vehicle and a control method thereof.

### BACKGROUND

In an autonomous driving system requiring little driver's intervention, it is essential to ensure the ability to distinguish and accurately recognize various objects and the surrounding environment. Here, in order to accurately recognize the objects and the surrounding environment, a deep learning algorithm is used.

In the autonomous driving system, deep learning can learn from the images acquired from the camera installed in the autonomous driving system, and the images acquired in real time are used as learning data to enhance the performance of deep learning.

The images as the learning data can be acquired only when the vehicle is actually driving, and the types of images that can be acquired by the vehicle are limited. For example, when the driver uses the vehicle only during the daytime, the vehicle lacks learning data for the nighttime image.

### SUMMARY

The disclosed invention relates to a vehicle and a control method thereof. Particular embodiments relate to enhancing a deep learning algorithm applied to an autonomous vehicle.

One embodiment of the disclosed invention provides a vehicle and a control method thereof capable of securing diversity of learning data.

A vehicle according to an embodiment of the disclosed invention includes a camera configured to acquire image data and a controller including at least one processor configured to process the image data acquired from the camera, wherein the controller configured to determine whether a light source or a texture is present in a first image acquired by processing the image data, perform filtering based on the light source or the texture being present, convert the filtered first image to a second image, and store the first and second images as learning data for object recognition.

The first image may include a daytime image, and the second image may include a nighttime image.

The controller may extract an H (value) channel per pixel in the first image, determine whether the light source is present based on the value of the H channel, and acquire a position of the light source in the first image.

The controller may exclude the first image from targets for conversion to the second image based on the light source being present in the first image.

The controller may change, based on the light source being present in the first image, a color around the light source in an area within a predetermined distance from the light source by referring to a hue saturation value (HSV) of a pixel in an area outside the predetermined distance.

The controller may determine whether the texture is present in the first image by applying fast Fourier transform (FFT) and high pass filter (HPF).

The controller may exclude the first image from targets for conversion to the second image based on the texture being present in the first image.

A method for controlling a vehicle according to an embodiment of the disclosed invention includes acquiring image data, determining whether a light source or a texture is present in a first image acquired by processing the image data, performing filtering based on the light source or the texture being present, converting the filtered first image to a second image, and storing the first and second images as learning data for object recognition.

In the method for controlling a vehicle according to an embodiment, the first image may include a daytime image, and the second image may include a nighttime image.

The performing filtering may include extracting an H (value) channel per pixel in the first image, determining whether the light source is present based on the value of the H channel, and acquiring a position of the light source in the first image.

The performing filtering may include excluding the first image from targets for conversion to the second image based on the light source being present in the first image.

The performing filtering may include changing, based on the light source being present in the first image, a color around the light source in an area within a predetermined distance from the light source by referring to a hue saturation value (HSV) of a pixel in an area outside the predetermined distance.

The performing filtering may include determining whether the texture is present in the first image by applying fast Fourier transform (FFT) and high pass filter (HPF).

The performing filtering may include excluding the first image from targets for conversion to the second image based on the texture being present in the first image.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a control block diagram of a vehicle according to an embodiment;

FIG. 2 is a diagram illustrating a system for generating learning data according to an embodiment;

FIG. 3 is a flowchart illustrating a method for controlling a vehicle according to an embodiment;

FIGS. 4 and 5 show a preprocessing process in the case where a light source is present in an image;

FIGS. 6 and 7 show a preprocessing process in the case where many textures exist in an image;

FIG. 8 shows a process of verification between a daytime image and a nighttime image; and

FIG. 9 shows a process of verification between a daytime image and a nighttime image using a brightness channel.

### DETAILED DESCRIPTION OF ILLUSTRATIVE EMBODIMENTS

Throughout the specification, the same reference numerals refer to the same components. This specification does not describe all elements of the embodiments of the disclosed invention, and well-known descriptions in the art or repeated descriptions between the embodiments of the disclosed invention are omitted. The terms unit, module, member, or block used in the specification may be implemented by software or hardware, and according to embodiments, it is also possible that a plurality of units, modules, members, or blocks are implemented as one component, or that one part, module, member, or block includes a plurality of components.

Throughout the specification, when a part is “connected” to another part, this includes a case of being directly connected as well as being connected indirectly, and indirect connection includes connecting through a wireless communication network.

Also, when a part is said to “comprise” a certain component, this means that other components may be further included instead of excluding other components unless specifically stated otherwise.

Throughout the specification, when one member is positioned “on” another member, this includes not only the case where one member abuts another member, but also the case where another member exists between the two members.

Terms such as first and second are used to distinguish one component from other components, and the component is not limited by the above-described terms.

A singular expression includes a plural expression unless the context clearly has an exception.

In each of steps, a reference numeral is used for convenience of description, the reference numerals do not describe the order of the steps, and the steps may be performed differently from the specified order, unless a specific order is explicitly stated in the context.

Hereinafter, the principle and embodiments of the disclosed invention will be described with reference to accompanying drawings.

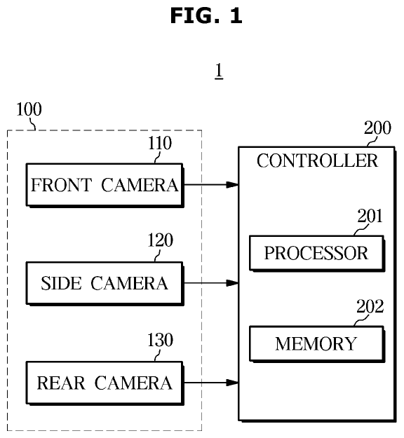

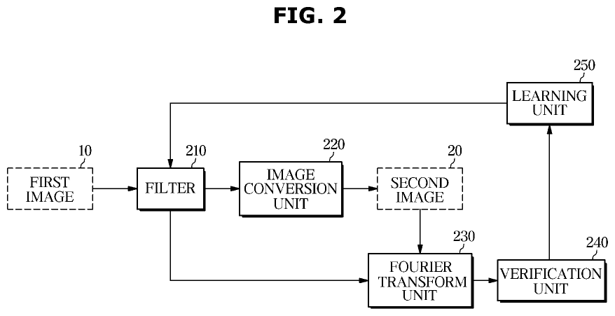

FIG. 1 is a control block diagram of a vehicle according to an embodiment, and FIG. 2 is a diagram illustrating a system for generating learning data according to an embodiment.

The vehicle 1 includes a sensor unit 100 including a front camera 110, a side camera 120, and a rear camera 130 to implement an autonomous driving system, and a controller 200 that performs image processing based on a signal transmitted from the sensor unit 100.

Although depicted as being configured only with the cameras in FIG. 1, the sensor unit 100 may obviously include a radar and a lidar mounted along with the cameras to recognize an object in a sensor fusion method.

The front camera 110 may be installed on the front windshield or the front bumper to secure a frontward sight of the vehicle 1. In this case, the front camera may detect an object moving in the frontward sight or detect an obstacle in the frontward sight. The front camera 110 transmits the image signal acquired from the frontward sight to the controller 200 such that the controller 200 processes the frontward image data.

The side camera 120 may be symmetrically installed on the B-pillar or the like in order to secure sideward sights of the vehicle 1. The side camera 120 may be provided on the left and right sides of the vehicle 1 to detect a moving object running side by side on the side of the vehicle 1 or a pedestrian approaching the vehicle 1. The side camera 120 transmits the image signal obtained from the sideward sight to the controller 200 such that the controller 200 processes the sideward image data.

The rear camera 130 may be installed on the rear windshield or the rear bumper in order to secure a rearward sight of the vehicle 1. In this case, the rear camera 130 may detect an object moving in the rearward sight or detect an obstacle in the rearward sight. The rear camera 130 transmits the image signal acquired from the rearward sight to the controller 200 such that the controller 200 processes the rearward image data.

Meanwhile, although described as having a total of 4 cameras above, the sensor unit 100 is not limited to the described example and may be configured with more cameras for more channels such as 6 channels, 8 channels, and 12 channels to improve recognition performance. In addition, it is obvious that the position of each camera can be changed to secure an optimal sight according to the structure of the vehicle 1.

The sensor unit 100 may include a plurality of lenses and an image sensor. The sensor unit 100 may be implemented as a wide-angle camera to secure an omnidirectional sight with respect to the vehicle 1.

The controller 200 may include an image signal processor 201 that processes image data of the sensor unit 100 and a micro controller (MCU) (not shown) that generates acceleration and deceleration signals, braking signals, and/or steering signals based on image data processing results.

When receiving image information (i.e., image data) from the sensor unit 100 in the autonomous driving mode, the controller 200 may perform image processing to recognize the lane demarcation lines of the road and resultantly the driving lane of the vehicle 1 based on the position information of the recognized lane demarcation lines, determine whether both lane demarcation lines of the vehicle's driving lane are recognized, and control, when determined that both lane demarcation lines are recognized, the autonomous driving based on the recognized lane demarcation lines.

When performing autonomous driving, the controller 200 may identify objects in the image based on the image information acquired by the sensor unit 100 and determine whether the objects in the image are fixed obstacles or moving obstacles using the disclosed deep learning algorithm.

Based on the image data of the sensor unit 100, the controller 200 may acquire location information (direction) and type information of obstacles in front of the vehicle 1 (e.g., whether the obstacle is another vehicle, a pedestrian, a cyclist, a curb, a guardrail, a street tree, or a street lamp).

The controller 200 may acquire the actual distance between the vehicle 1 and the object for each direction based on the image data of the sensor unit 100.

The memory 202 may store programs and/or data for processing image data, programs and/or data for processing radar data, and programs and/or data for the processor 201 to generate braking and/or warning signals.

The memory 202 may temporarily store processing results of the image data and the image data received from the sensor unit 100.

The memory 202 may be implemented with, but without being limited to, at least one of storage media including a non-volatile memory device such as a cache, a read only memory (ROM), a programmable ROM (PROM), an erasable programmable ROM (EPROM), an electrically erasable programmable ROM (EEPROM), and a flash memory, and a volatile memory device such as a random access memory (RAM), a hard disk drive (HDD), or a compact disc-ROM (CD-ROM).

Embodiments of the present invention recognize objects and the surrounding environment through deep learning-based image recognition. Here, the deep learning model for image recognition uses image data acquired from the sensor unit 100 as learning data.

Meanwhile, in order to improve the performance of the above-described deep learning model, a large amount of learning data (dataset) is required. The vehicle 1 stores the image data received from the sensor unit 100 and the processing result of the image data in order to accumulate the learning data.

However, the learning data is limited in diversity depending on the driving time and driving place of the vehicle 1. For example, when the vehicle 1 is operated only during the daytime, only the daytime images are accumulated in the memory 202, lacking in learning about nighttime images. Accordingly, the image recognition performance is deteriorated during night driving compared to during daytime driving.

Embodiments of the present invention can convert a daytime image into a nighttime image through an algorithm to be described later and use the high-quality images as an input of an object recognizer for autonomous driving. Embodiments of the present invention induce the creation of a deep learning model capable of better performance by applying feedback to the filter part based on the performances from the recognizer.

An embodiment of the present disclosure secures diversity of learning data by converting the images obtained from the sensor unit 100 using image-to-image translation. As an image-to-image translation method (hereinafter, collectively referred to as a conversion technique), unsupervised image-to-image translation networks (UNIT), pix2pix, and CycleGAN techniques may be used.

The controller 200 may convert a daytime image into a nighttime image or convert a black-and-white image into a color image using conversion techniques. In addition, it is also possible to convert a sunny weather image into a rainy or snowy weather image.

Meanwhile, when converting an image acquired while driving the vehicle 1, the following problem occurs, unlike converting a general image. For example, if there is a strong light source (e.g., sun or streetlight) in the image or there are too many textures (texture, border points, and border lines unnecessary for object classification), the image is blurred in a specific area.

In order to solve the above problems, embodiments of the present invention perform a separate preprocessing process before converting the image. By performing the preprocessing process followed by image conversion, it is possible to secure the diversity of training data for improving the performance of the deep learning model. The preprocessing process will be described later in detail.

With reference to FIG. 2, the first image 10 is input to the filter 210. Here, the first image 10 is an image acquired through the sensor unit 100 and corresponds to data that has not been converted or processed separately.

When the first image 10 is a daytime image, the second image 20 is a nighttime image. When the first image 10 is a nighttime image, the second image 20 is a daytime image. When the first image 10 is a sunny weather image, the second image 20 may be a rainy or snowy weather image.

The filter 210 is configured to remove a light source or a texture in the first image 10 before converting the first image 10. In the case where the sun is in the first image 10, the difference in brightness from the sun to a certain area is large such that, when converted to a nighttime image, the image is blurred. Accordingly, the light source must be removed in the first image 10 through the filter 210.

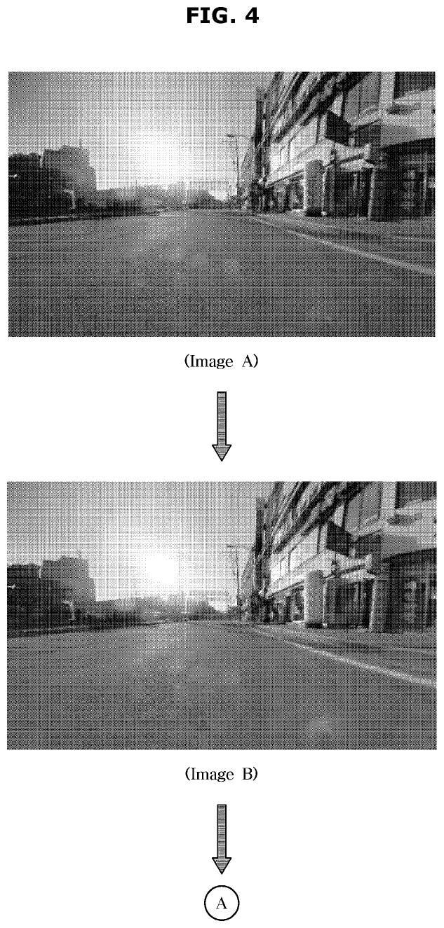

The filter 210 may use a V (Value, Brightness) channel among HSV (Hue, Saturation, Value) channels to determine whether a light source is present in the first image 10. In addition, the filter 210 may use a Fast Fourier Transform (FFT) and/or a High Pass Filter (HPF) to determine whether a texture is present in the first image 10. The filtering process will be described in more detail with reference to FIGS. 4 to 7.

With reference to FIG. 4, the first image 10 shown in image A is converted into HSV channels per pixel, and a V channel is extracted from the HSV channels (A->B). As shown in image B, the brightness value is higher at and around the point where the light source (sun) is located than that at other pixels.

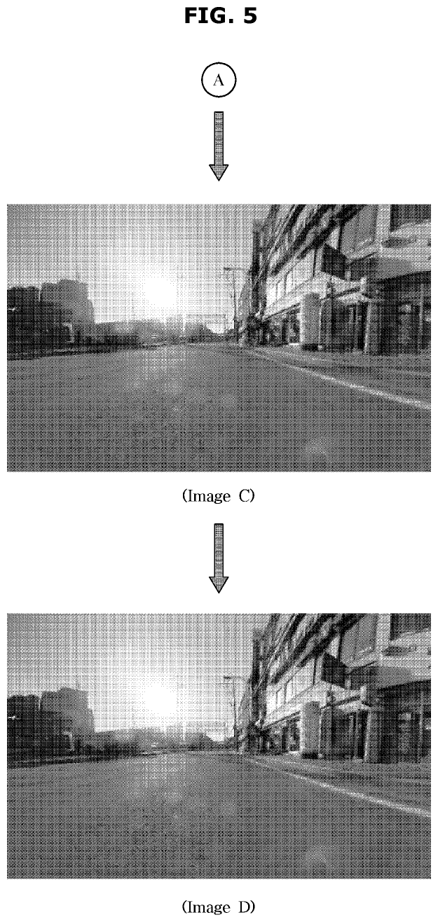

With reference to FIG. 5, the controller 200 extracts coordinates having the highest brightness value from the first image 10 converted into a V channel (image C), forms a certain area based on the coordinates (image D), and calculates a standard deviation value of brightness within the certain area. Here, if the standard deviation is equal to or greater than a predetermined value, the controller 200 may determine that the light source is present in the first image 10.

Meanwhile, even when a texture is present in the image in addition to the light source, the image may be blurred during conversion. If there are many textures in the image, it may help strengthen the learning data by skipping performing the conversion.

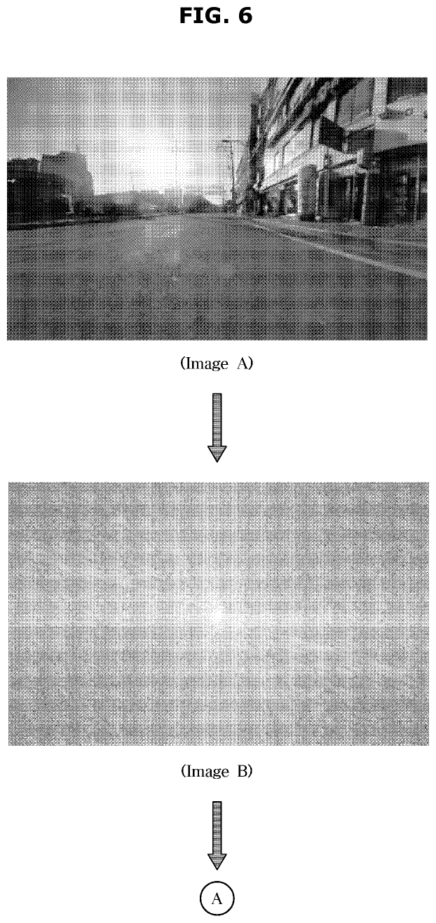

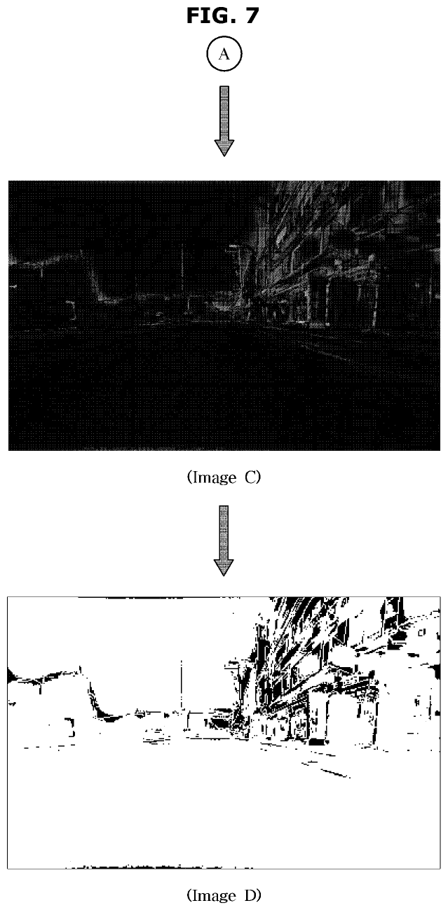

With reference to FIGS. 6 and 7, FFT is performed on the first image 10 shown in image A to be transformed into a frequency domain per pixel as shown in image B (A->B). After removing the low frequency by applying HPF to the FFT'ed image, Inverse Fast Fourier Transform (IFFT) is performed to transform the frequency domain back to an image as shown in image C (B->C).

Here, in order to extract edges forming a texture in the image, the controller 200 extracts only edges having an edge size higher than a predetermined threshold value to generate an image as shown in image D (C->D). Next, if the ratio of the extracted edge pixels to the total pixels is equal to or greater than a predetermined ratio, the controller 200 may determine that there are many textures interfering with image conversion so as to exclude the corresponding image from targets for conversion.

The image conversion unit 220 converts the first image 10 into the second image 20. The image conversion unit 220 may use unsupervised image-to-image translation networks (UNIT), pix2pix, CycleGAN, etc. as an image conversion technique.

The image conversion unit 220 may convert a daytime image into a nighttime image, convert a nighttime image into a daytime image, or convert a sunny weather image into a snowy or rainy weather image. Also, on the contrary, it may also be possible to convert a snowy or rainy weather image into a sunny weather image.

When the image conversion unit 220 generates the converted second image 20, a verification process is performed through the verification unit 240.

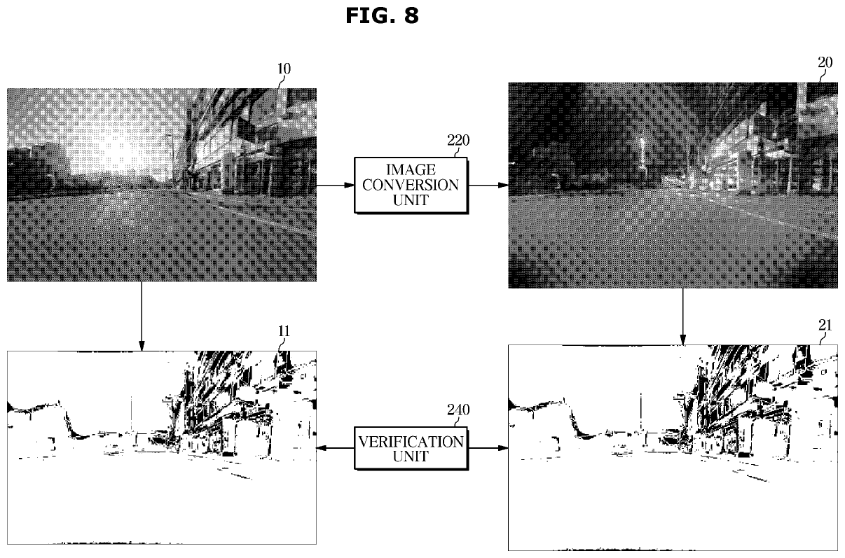

The Fourier transform unit 230 performs FFT and/or HPF on the first and second images 10 and 20 to extract respective edges and determine the similarity between the images. Here, with reference to FIG. 8, the first image 10 is converted into the second image 20, which is a nighttime image, through the image conversion unit 220, and the first and second images 10 and 20 are each converted into pixel-specific edge images on which the verification unit 240 performs a verification process. The verification unit 240 may perform the first verification process through edge extraction on each of the first and second images 10 and 20.

Meanwhile, after the first verification process is performed, a second verification process may be performed additionally. If the first verification process through edge extraction is to compare local information of the image, the second verification process is to determine whether the daytime image is properly converted into a nighttime image using the HSV channels.

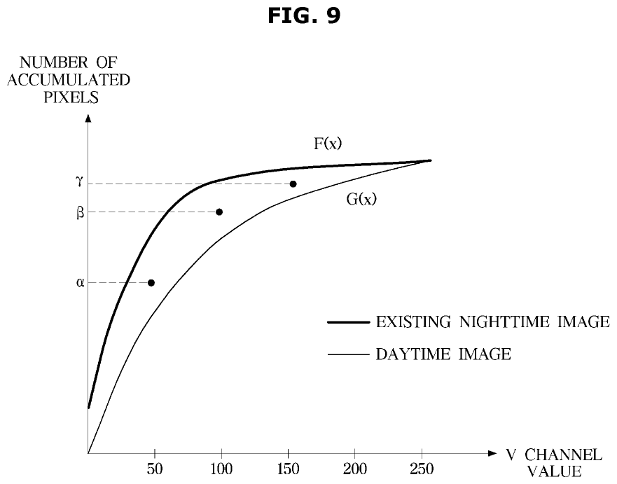

With reference to FIG. 9, the controller 200 extracts the V channel of the daytime images and the existing nighttime images and generates a graph in which the number of pixels present for each value (0 to 255) of the V channel is calculated. In the graph, the brightness distributions of the daytime images and the existing nighttime images are classified into two, and the average value is reflected by identifying the number of accumulated pixels for each channel value of the daytime image and the existing nighttime image.

Because the nighttime image shows a high increase rate at a low value, there will be a difference from the daytime image.

When the V channel values are 50, 100, and 150, the average of the number of accumulated pixels of the daytime image and the existing nighttime image is a, P, and y, and the controller 200 compares the number of pixels accumulated when the V channel values of the converted nighttime image are 50, 100, and 150 with a, P, and y. As a result of comparison, if the number of accumulated pixels for each V channel value of the converted nighttime image is two or more, it can be seen that the converted nighttime image from the daytime image reflects the characteristics of the nighttime image as well as the existing nighttime image.

The learning unit 250 trains the deep learning model based on the first image 10 and the second image 20 converted completely. The learning unit 250 may train the deep learning model based on the daytime image and the converted nighttime image and may adjust a predetermined value as a comparison target of the standard deviation referred to in FIG. 5 or a predetermined ratio of the standard deviation referred to in FIG. 7 based on the result of the evaluation of the recognition performance.

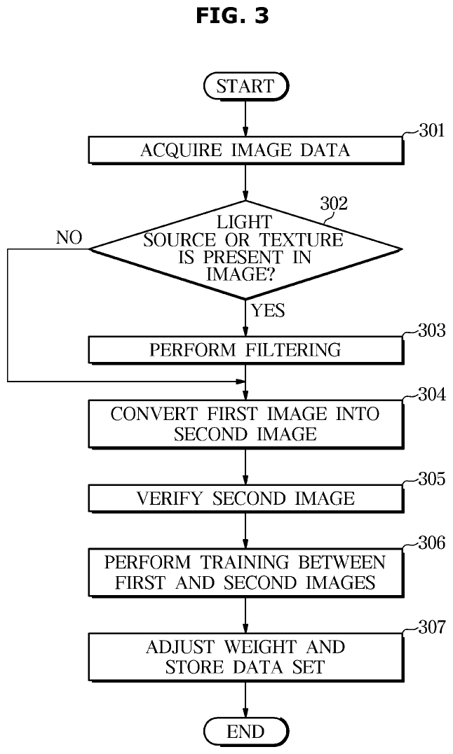

FIG. 3 is a flowchart illustrating a method for controlling a vehicle according to an embodiment.

The controller 200 acquires image data at step 301. The image data is an image before conversion and corresponds to the image directly provided by the sensor unit 100. Here, the image corresponds to data that has not been separately converted or processed.

The controller 200 determines at step 302 whether a light source or a texture is present in the image. The controller 200 may use a V (Value, brightness) channel among HSV (Hue, Saturation, Value) channels to determine whether there is a light source or use Fast Fourier Transform (FFT) and/or a high pass filter (HPF) to determine whether there is a texture.

The controller 200 performs, at step 303, filtering on an image having a light source or a texture. When a light source is present in the image, the controller 200 may filter the first image 10 by changing the color around the light source by referring to the HSV of pixels in an area outside the predetermined distance from the light source. In addition, the filtering may be performed by excluding the first image 10 having a light source from targets for conversion.

Also, when a texture is present in the image, the controller 200 may perform filtering by excluding the first image 10 from targets for conversion.

When the filtering is completed, the controller 200 converts the first image 10 into the second image 20 at step 304. The controller 200 may convert a daytime image into a nighttime image using an image conversion technique such as Unsupervised Image-to-Image Translation Networks (UNIT), pix2pix, CycleGAN, or the like.

When the second image 20 is generated through the conversion process, the controller 200 verifies the second image 20 at step 305. The controller 200 may extract edges from each of the daytime and nighttime images using FFT and HPF used in the filtering process, compare the images for similarity therebetween, and determine whether the daytime image has been well converted into a nighttime image through a histogram.

The controller 200 performs, at step 306, training on the deep learning model based on the first image 10 and the second image 20 converted completely. The learning unit 250 may train the deep learning model based on the daytime image and the converted nighttime image and evaluate the recognition performance.

The controller 200 may adjust the weight of the deep learning model or store a data set including the first image 10 and the second image 20 at step 307. The weight may include a predetermined value as a comparison target of standard deviation or a predetermined ratio as a comparison target of edge extraction.

Training for autonomous driving and feeding back the outputs of the object recognizer, which receives inputs, to the filter is capable of achieving better performance.

That is, embodiments of the present invention can be viewed as a data conversion system including a preprocessing process for creating nighttime images using only daytime images and can provide a variety of learning data for object recognition for autonomous driving.

According to one embodiment of the disclosed invention, it is possible to enhance the deep learning performance in the autonomous driving system by securing the diversity of learning data. Accordingly, it is possible to improve the accuracy of object recognition.

Meanwhile, the disclosed embodiments may be implemented in the form of a recording medium storing instructions executable by a computer. The instruction may be stored in the form of a program code, and when executed by a processor, a program module may be generated to perform operations of the disclosed embodiments. The recording medium may be implemented as a computer-readable recording medium.

The computer-readable recording medium includes any type of recording medium in which instructions readable by the computer are stored. For example, there may be a read only memory (ROM), a random access memory (RAM), a magnetic tape, a magnetic disk, a flash memory, an optical data storage device, and the like.

The disclosed embodiments have been described as above with reference to the accompanying drawings. Those skilled in the art will understand that the present invention may be implemented in a form different from the disclosed embodiments without changing the technical spirit or essential features of the present invention. The disclosed embodiments are illustrative and should not be construed as limiting.

What is claimed is:

1. A vehicle comprising:
a camera; and
a controller comprising a processor configured to process image data acquired from the camera, wherein the controller is configured to:
determine whether a light source or a texture is present in a first image acquired by processing the image data;
perform filtering of the first image based on the light source or the texture being present;
convert the first image into a second image; and
store the first image and the second image as learning data for object recognition.

2. The vehicle of claim 1, wherein the first image comprises a daytime image and the second image comprises a nighttime image.

3. The vehicle of claim 2, wherein the controller is configured to extract an H channel per pixel in the first image, determine whether the light source is present based on a value of the H channel, and acquire a position of the light source in the first image.

4. The vehicle of claim 3, wherein the controller is configured to exclude the first image from targets for conversion to the second image based on the light source being present in the first image.

5. The vehicle of claim 3, wherein the controller is configured to change, based on the light source being present in the first image, a color around the light source in an area within a predetermined distance from the light source by referring to a hue saturation value of a pixel in an area outside the predetermined distance.

6. The vehicle of claim 3, wherein the controller is configured to determine whether the texture is present in the first image by applying a fast Fourier transform and a high pass filter.

7. The vehicle of claim 6, wherein the controller is configured to exclude the first image from targets for conversion to the second image based on the texture being present in the first image.

8. A method for controlling a vehicle, the method comprising:
acquiring image data;
determining whether a light source or a texture is present in a first image acquired by processing the image data;
performing filtering on the first image based on the light source or the texture being present;
converting the first image into a second image; and
storing the first image and the second image as learning data for object recognition.

9. The method of claim 8, wherein the first image comprises a daytime image and the second image comprises a nighttime image.

10. The method of claim 9, wherein performing filtering comprises extracting an H channel per pixel in the first image, determining whether the light source is present based on a value of the H channel, and acquiring a position of the light source in the first image.

11. The method of claim 10, wherein performing filtering comprises excluding the first image from targets for conversion to the second image based on the light source being present in the first image.

12. The method of claim 10, wherein performing filtering comprises changing, based on the light source being present in the first image, a color around the light source in an area within a predetermined distance from the light source by referring to a hue saturation value of a pixel in an area outside the predetermined distance.

13. The method of claim 10, wherein performing filtering comprises determining whether the texture is present in the first image by applying a fast Fourier transform (FFT) and a high pass filter (HPF).

14. The method of claim 13, wherein performing filtering comprises excluding the first image from targets for conversion to the second image based on the texture being present in the first image.

15. A system comprising:
a sensor unit comprising a plurality of cameras; and
a controller comprising a memory and a processor configured to process image data acquired from the sensor unit, wherein the controller is configured to:
determine whether a light source or a texture is present in a first image acquired by processing the image data;
perform filtering of the first image based on the light source or the texture being present;
convert the first image into a second image; and
store the first image and the second image in the memory as learning data for object recognition.

16. The system of claim 15, wherein the first image comprises a daytime image and the second image comprises a nighttime image.

17. The system of claim 15, wherein the controller is configured to extract an H channel per pixel in the first image, determine whether the light source is present based on a value of the H channel, and acquire a position of the light source in the first image.

18. The system of claim 17, wherein the controller is configured to exclude the first image from targets for conversion to the second image based on the light source being present in the first image.

19. The system of claim 17, wherein the controller is configured to change, based on the light source being present in the first image, a color around the light source in an area within a predetermined distance from the light source by referring to a hue saturation value of a pixel in an area outside the predetermined distance.

20. The system of claim 17, wherein the controller is configured to determine whether the texture is present in the first image by applying a fast Fourier transform and a high pass filter and to exclude the first image from targets for conversion to the second image based on the texture being present in the first image.
